(19) United States
(12) Patent Application Publication
(10) Pub. No.: US 2021/0372532 A1
(43) Pub. Date: Dec. 2, 2021

(54) VALVE DEVICE

(71) Applicant: FUJIKIN INCORPORATED, Osaka (JP)

(72) Inventors: Ryutaro TANNO, Osaka (JP); Tomohiro NAKATA, Osaka (JP); Toshihide YOSHIDA, Osaka (JP); Kenta KONDO, Osaka (JP); Yuya SUZUKI, Osaka (JP); Tsutomu SHINOHARA, Osaka (JP)

(21) Appl. No.: 17/405,588

(22) Filed: Aug. 18, 2021

Related U.S. Application Data
(63) Continuation of application No. PCT/JP2020/006061, filed on Feb. 17, 2020.

(30) Foreign Application Priority Data
Feb. 19, 2019 (JP) 2019-027669

(51) Int. Cl. F16K 1/52; F16K 27/02; F16K 37/00

(52) U.S. Cl. CPC F16K 1/52; F16K 37/00; F16K 27/02

(57) ABSTRACT

A valve device includes: a body in which an in-flow path and an out-flow path are formed; a valve element that is configured to open and close the in-flow path and the out-flow path; a stem that is configured to move closer to and away from the body in order to cause the valve element to allow and block communication between the in-flow path and the out-flow path; a stroke adjustment portion that is configured to adjust an amount of stroke of the stem; and a displacement sensor that is configured to detect displacement of the stem.

### CROSS REFERENCE TO RELATED APPLICATION

This application is a continuation under 35 U.S.C. § 120 of PCT/JP2020/006061, filed Feb. 17, 2020, which is incorporated herein reference and which claimed priority to Japanese Application No. 2019-027669, filed Feb. 19, 2019. The present application likewise claims priority under 35 U.S.C. § 119 to Japanese Application No. 2019-027669, filed Feb. 19, 2019, the entire content of which is also incorporated herein by reference

### TECHINICAL FIELD

The present disclosure relates a valve device for use in a semiconductor manufacturing device etc.

### BACKGROUND

Japanese Patent Application Publication No. 2003-14155 proposes a valve device that is opened and closed by a drive fluid, the valve device having adjustment means for adjusting the flow rate of the fluid by adjusting an open/close lift of an open/close element by an air cylinder.

### SUMMARY

With the valve device according to Japanese Patent Application Publication No. 2003-14155, however, it is not possible to grasp how much the lift amount of the open/close element is actually varied after adjusting the open/close lift.

Therefore, one of the objects of the present disclosure is to provide a valve device that makes it possible to grasp the stroke amount of a stem.

A valve device according to one or more embodiments of the present disclosure includes: a body in which an in-flow path and an out-flow path are formed; a valve element that is configured to open and close the in-flow path and the out-flow path; a stem that is configured to move closer to and away from the body in order to cause the valve element to allow and block communication between the in-flow path and the out-flow path; a stroke adjustment portion that is configured to adjust an amount of stroke of the stem; and a displacement sensor that is configured to detect displacement of the stem.

### BRIEF DESCRIPTION OF THE DRAWINGS

In the drawings:

FIG. 1 is a sectional view of a valve device according to an embodiment;

FIG. 2 is an enlarged sectional view of the vicinity of a flange of a stem of the valve device;

FIG. 3 indicates an example of a signal output from a sensor portion; and

FIG. 4 is a flowchart of a stroke calculation process.

### DETAILED DESCRIPTION

A valve device according to an embodiment of the present disclosure will be described with reference to the drawings.

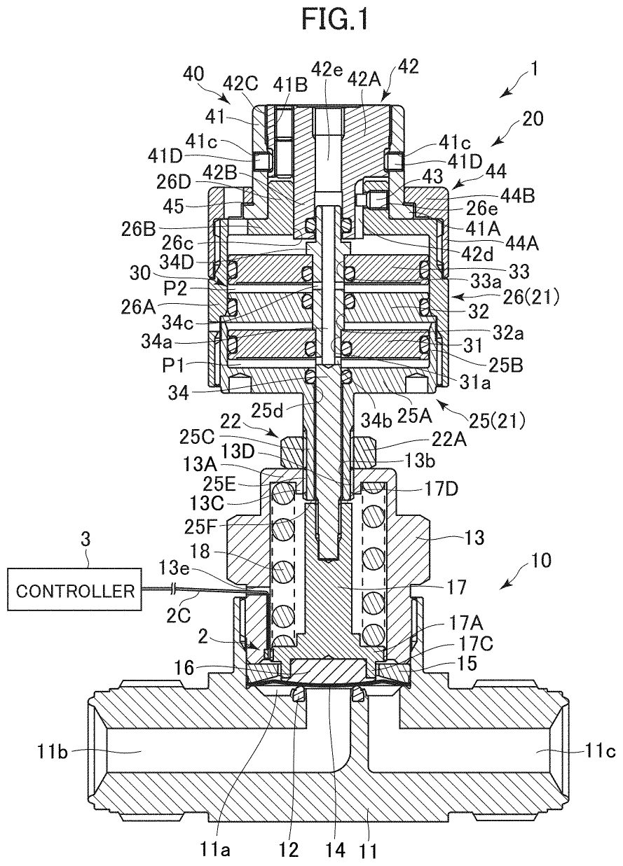

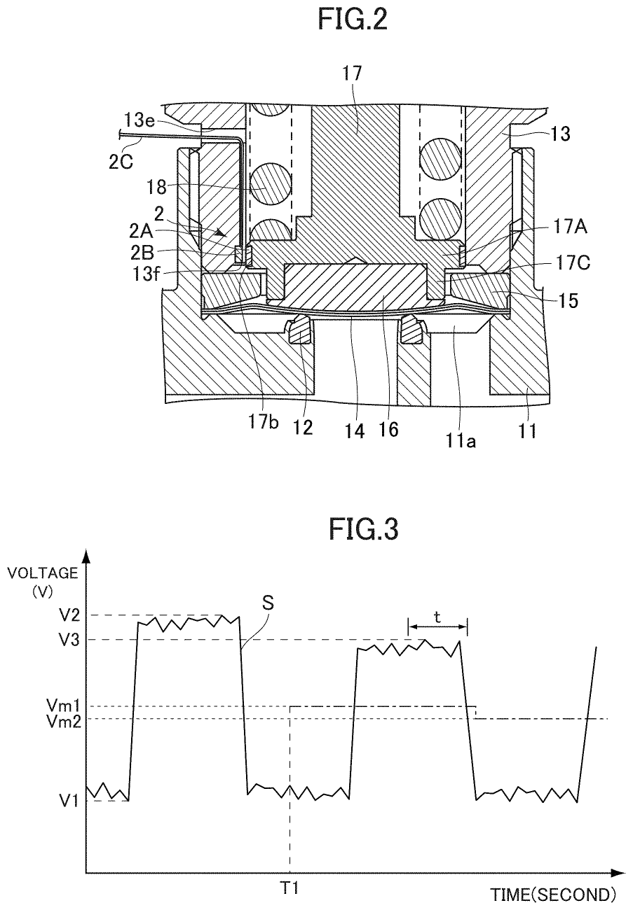

FIG. 1 is a sectional view of a valve device 1 according to the present embodiment. FIG. 2 is an enlarged sectional view of the vicinity of a flange 17A of a stem 17 of the valve device 1. The valve device 1 according to the present embodiment is a diaphragm valve.

As illustrated in FIG. 1, the valve device 1 includes a body 10, an actuator 20, a sensor portion 2, and a controller 3. In the following description, the side of the actuator 20 of the valve device 1 is defined as the upper side, and the side of the body 10 is defined as the lower side.

### Body 10

The body 10 includes a body main body 11, a seat 12, a bonnet 13, a diaphragm 14, a pressing adapter 15, a diaphragm presser 16, a stem 17, and a compression coil spring 18.

A valve chamber 11a and an in-flow path 11b and an out-flow path 11c that communicate with the valve chamber 11a are formed in the body main body 11. The seat 12 is in an annular shape, and is provided at the peripheral edge of a location at which the valve chamber 11a and the in-flow path 11b communicate with each other.

The bonnet 13 is in a generally cylindrical shape with a lid, and is fixed to the body main body 11 so as to cover the valve chamber 11a by screwing a male threaded portion provided at the outer periphery of the lower end portion of the bonnet 13 into a female threaded portion provided in the body main body 11.

A first through hole 13b is formed at the center portion of a top wall portion 13A of the bonnet 13. A first downward projecting portion 13C in the shape of a cylinder that projects downward is provided on the lower surface of the top wall portion 13A and at the peripheral edge portion of the first through hole 13b. A female threaded portion 13D is provided at the inner periphery of the first through hole 13b and the first downward projecting portion 13C. A second through hole 13e for detecting gas leakage is formed in the bonnet 13 to penetrate the bonnet 13 in a direction that is orthogonal to the axis of the bonnet 13. An accommodation recessed portion 13f (FIG. 2) that accommodates a Hall integrated circuit (IC) 2B, to be discussed later, is formed at the inner periphery of the bonnet 13 and below the second through hole 13e. The first through hole 13b, the inner periphery of the first downward projecting portion 13C, and the female threaded portion 13D correspond to the first threaded hole.

The diaphragm 14, which serves as a valve element, is held with its outer peripheral edge portion pressed between the pressing adapter 15, which is disposed at the lower end of the bonnet 13, and the bottom surface of the body main body 11, which forms the valve chamber 11a. The diaphragm 14 is in a spherical shell shape, and in an arcuate shape that is convex upward in the natural state. The fluid passage is opened and closed when the diaphragm 14 is moved away from and into abutment with the seat 12. The diaphragm 14 is constituted from a plurality of metal thin sheets, which are punched into a circular shape and formed into a spherical shell shape, the center portion of which is swelled upward, for example.

The diaphragm presser 16 is provided on the diaphragm 14, and configured to press the center portion of the diaphragm 14.

The stem 17 is in a generally circular column shape, and is disposed in the bonnet 13 so as to be movable up and down. A flange 17A is provided at the lower end of the stem 17. A magnet accommodation groove 17b (FIG. 2) in an annular shape that is continuous for the entire circumference is formed in the outer peripheral surface of the flange 17A. The accommodation recessed portion 13f and the magnet accommodation groove 17b face each other in the radial direction. A third downward projecting portion 17C in the shape of a cylinder that projects downward is provided on the lower surface side of the flange 17A. The diaphragm presser 16 is fitted in the third downward projecting portion 17C.

The compression coil spring 18 is provided between the top wall portion 13A of the bonnet 13 and the flange 17A of the stem 17. The compression coil spring 18 biases the stem 17 downward at all times. Therefore, the valve device 1 is kept in the closed state normally (when a drive portion 30 is not driven) by the compression coil spring 18.

### Actuator 20

The actuator 20 includes a casing 21, a first stroke adjustment portion 22, a drive portion 30, and a second stroke adjustment portion 40. The casing 21 has a lower casing 25 and an upper casing 26, the lower end portion of which is screwed to the upper end portion of the lower casing 25.

The lower casing 25 has a bottom portion 25A, a first upward projecting portion 25B, and a second downward projecting portion 25C. The bottom portion 25A is in a disk shape. A third through hole 25d is formed at the center portion of the bottom portion 25A. The first upward projecting portion 25B is in a cylindrical shape, and is provided so as to project upward from the outer peripheral edge of the bottom portion 25A. The second downward projecting portion 25C is provided so as to project downward from the peripheral edge portion of the third through hole 25d. A male threaded portion 25E is provided at the outer periphery of the lower portion of the second downward projecting portion 25C. The lower portion of the male threaded portion 25E of the second downward projecting portion 25C is screwed into the female threaded portion 13D of the bonnet 13. The second downward projecting portion 25C corresponds to the threaded engagement portion. The male threaded portion 25E corresponds to the first threaded portion.

The upper casing 26 is in a generally cylindrical shape with a lid, and has a peripheral wall portion 26A and a top wall portion 26B. A fourth through hole 26c is formed at the center portion of the top wall portion 26B. A second upward projecting portion 26D in the shape of a cylinder that projects upward is provided on the upper surface of the top wall portion 26B and at the peripheral edge portion of the fourth through hole 26c. A screw hole 26e is formed in the second upward projecting portion 26D to penetrate the second upward projecting portion 26D in a direction that is orthogonal to the axis of the second upward projecting portion 26D.

The first stroke adjustment portion 22 has a nut 22A. The nut 22A is screwed on the upper portion of the male threaded portion 25E of the second downward projecting portion 25C. Turning of the lower casing 25 relative to the bonnet 13 is suppressed when the nut 22A abuts against the top wall portion 13A. Suppression on turning of the lower casing 25 is canceled by loosening the nut 22A. The lower casing 25 can be moved up and down with respect to the body 10 by turning the lower casing 25.

When the stem 17 moves upward, an upper surface 17D of the stem 17 abuts against a lower surface 25F of the second downward projecting portion 25C of the lower casing 25, which hinders further upward movement of the stem 17. The stroke amount (lift amount) of the stem 17 can be set to a desired value by rotating the lower casing 25 with the nut 22A loosened. That is, the upper limit value of the amount of upward movement of the stem 17 can be set to a desired value. The nut 22A, the male threaded portion 25E of the second downward projecting portion 25C, and the female threaded portion 13D of the bonnet 13 constitute the first stroke adjustment portion 22.

### Drive Portion 30

The drive portion 30 has a first piston 31, a partition disk 32, a second piston 33, and a drive shaft 34.

The first piston 31 is in a generally disk shape. A fifth through hole 31a penetrated by the drive shaft 34 is formed at the center portion of the first piston 31. The first piston 31 and the lower casing 25 form a first pressure chamber P1.

The partition disk 32 is in a generally disk shape. A sixth through hole 32a penetrated by the drive shaft 34 is formed at the center portion of the partition disk 32. The partition disk 32 is fixed to the inner periphery of the upper casing 26 so as not to be movable.

The second piston 33 is in a generally disk shape. A seventh through hole 33a penetrated by the drive shaft 34 is formed at the center portion of the second piston 33. The second piston 33, the partition disk 32, and the upper casing 26 form a second pressure chamber P2.

The drive shaft 34 is in a generally circular column shape, and is provided so as to be movable in the up-down direction. The drive shaft 34 extends from the bonnet 13 to a small-diameter portion 42B of a movable disk 42, to be discussed later, through the second downward projecting portion 25C of the lower casing 25. The lower end portion of the drive shaft 34 is screwed to the stem 17 with the outside diameter of the lower end portion of the drive shaft 34 configured to be smaller than the outside diameter of the stem 17.

A fluid flow path 34a that extends in the up-down direction is formed in the upper half of the drive shaft 34. Further, first and second fluid out-flow holes 34b and 34c that cross the fluid flow path 34a are formed in the upper half of the drive shaft 34. The upper end of the fluid flow path 34a opens in the upper surface of the drive shaft 34. The first fluid out-flow hole 34b communicates with the first pressure chamber P1. The second fluid out-flow hole 34c is positioned above the first fluid out-flow hole 34b, and communicates with the second pressure chamber P2.

The drive shaft 34 includes a flange 34D provided at a portion positioned between the second piston 33 and the small-diameter portion 42B of the movable disk 42, to be discussed later. The flange 34D abuts against the upper surface of the second piston 33. Consequently, the drive shaft 34 and the stem 17 are moved upward when the second piston 33 is moved upward.

The second stroke adjustment portion 40 includes a handle 41, a movable disk 42, a guide pin 43, a pressing ring 44, and a washer 45.

The handle 41 is in a cylindrical shape, positioned on the outer side of the second upward projecting portion 26D, and disposed on the top wall portion 26B of the upper casing 26 so as to be rotatable. A flange 41A is provided at the lower end portion of the handle 41. A female threaded portion 41B is provided at the inner periphery of the upper portion of the handle 41. A screw hole 41c is formed in the handle 41 at two locations in the circumferential direction thereof. A fixing screw 41D is screwed into the screw hole 41c to abut against the outer peripheral surface of the movable disk 42 to regulate upward and downward movement and rotation of the movable disk 42. The inner periphery of the upper portion of the handle 41 and the female threaded portion 41B correspond to the second threaded hole.

The movable disk 42 has a large-diameter portion 42A and a small-diameter portion 42B that is positioned below the large-diameter portion 42A and that is smaller in outside diameter than the large-diameter portion 42A. The large-diameter portion 42A is disposed such that the lower surface thereof can abut against the upper surface of the second upward projecting portion 26D. The small-diameter portion 42B is positioned in the second upward projecting portion 26D. A male threaded portion 42C is provided at the outer periphery of the large-diameter portion 42A. The male threaded portion 42C of the large-diameter portion 42A and the female threaded portion 41B of the handle 41 are screwed to each other. Therefore, the movable disk 42 is moved upward and downward by rotating the handle 41. The pitch of the male threaded portion 42C and the female threaded portion 41B of the second stroke adjustment portion 40 is smaller than the pitch of the male threaded portion 25E and the female threaded portion 13D of the first stroke adjustment portion 22. Therefore, the stroke of the stem 17 can be adjusted roughly using the first stroke adjustment portion 22, and the stroke of the stem 17 can be adjusted finely using the second stroke adjustment portion 40. A guide groove 42d that extends in the up-down direction is formed at the outer periphery of the small-diameter portion 42B. The guide groove 42d and the screw hole 26e in the second upward projecting portion 26D are adjacent to each other in the radial direction. The male threaded portion 42C corresponds to the second threaded portion.

A fluid introduction path 42e is formed to penetrate the movable disk 42 in the up-down direction. A pipe joint (not illustrated) is mounted to the upper end portion of the fluid introduction path 42e. The upper end portion of the drive shaft 34 is inserted into the lower end portion of the fluid introduction path 42e. Consequently, the fluid introduction path 42e and the fluid flow path 34a communicate with each other.

The guide pin 43 is screwed into the screw hole 26e in the second upward projecting portion 26D. The distal end of the guide pin 43 is positioned in the guide groove 42d. Consequently, the movable disk 42 is configured to be non-rotatable, and movable in the up-down direction, with respect to the upper casing 26.

The pressing ring 44 is in a generally cylindrical shape, and has a peripheral wall portion 44A and an inward projecting portion 44B. The inner periphery of the peripheral wall portion 44A is screwed to the outer periphery of the upper end portion of the upper casing 26. The inward projecting portion 44B is in an annular shape, and projects inward from the upper end of the peripheral wall portion 44A to cover the top wall portion 26B of the upper casing 26 and the flange 41A of the handle 41.

Fluorocarbon resin coating is applied to the surface of the washer 45. The washer 45 is provided between the flange 41A and the inward projecting portion 44B. The material for coating the washer 45 is not restricted to a fluorocarbon resin. The washer 45 may be replaced with a thrust bearing, a ball bearing, etc. The operability of the handle 41 can be improved in the valve device 1 in the open state by providing the washer 45.

### Sensor Portion 2

The sensor portion 2 is a displacement sensor that detects displacement of the stem 17, and is a Hall sensor that has a magnet 2A, a Hall IC (Integrated Circuit) 2B, and a wire 2C as illustrated in FIG. 2. The magnet 2A is in a circular ring shape, and is accommodated in the magnet accommodation groove 17b in the flange 17A of the stem 17. The Hall IC 2B is accommodated in the accommodation recessed portion 13f. The Hall IC 2B has a Hall element and an amplification circuit such as an operational amplifier. The wire 2C is connected to the Hall IC 2B, and extends to the outside via the second through hole 13e to be connected to the controller 3.

When the position of the magnet 2A which is provided in the stem 17 is varied with a certain current flowing through the Hall element of the Hall IC 2B, a voltage that matches the magnetic flux density is output from the Hall element. When the output voltage is amplified by the operational amplifier and subjected to signal processing, a signal that matches the magnetic flux density is output from the Hall IC 2B to the controller 3. The stroke amount of the stem 17 can be grasped in accordance with the output signal.

FIG. 3 indicates an example of the signal output from the sensor portion 2. The vertical axis represents the voltage (V). The horizontal axis represents the time (second).

As indicated in FIG. 3, a signal S that indicates a low voltage when the valve device 1 is closed and that indicates a high voltage when the valve device 1 is open is obtained. The signal S contains noise due to the internal gas pressure, vibration, an electromagnetic wave, a resistance, etc.

### Controller 3

The controller 3 includes a central processing unit (CPU) and a storage unit. The storage unit stores various programs. A stroke calculation process, to be discussed later, is performed by the CPU reading and executing the programs.

### Open/Close Operation of Valve Device 1

Next, open/close operation of the valve device 1 according to the present embodiment will be described.

In the valve device 1 according to the present embodiment, when a drive fluid does not flow into the first and second pressure chambers P1 and P2, the valve device 1 is in the closed state with the stem 17 located at the bottom dead center (proximate to the body main body 11) because of the biasing force of the compression coil spring 18 and with the diaphragm 14 pressed by the diaphragm presser 16. That is, the valve device 1 is in the closed state normally (when a drive fluid is not supplied).

Then, a drive fluid flows from a drive fluid supply source (not illustrated) to the valve device 1. Consequently, the drive fluid is supplied to the valve device 1. The drive fluid passes through the fluid introduction path 42e and the fluid flow path 34a via an air tube and a pipe joint (not illustrated), and passes through the first and second fluid out-flow holes 34b and 34c to flow into the first and second pressure chambers P1 and P2. When the drive fluid flows into the first and second pressure chambers P1 and P2, the first and second pistons 31 and 33 are raised against the biasing force of the compression coil spring 18. Consequently, the valve device 1 is brought into the open state with the stem 17 and the drive shaft 34 moved to the top dead center (away from the body main body 11) and with the diaphragm presser 16 moved upward by the elastic force of the diaphragm 14 and the pressure of the fluid (gas) to communicate the in-flow path 11b and the out-flow path 11c with each other.

To bring the valve device 1 from the open state to the closed state, a three-way valve (not illustrated) is switched to a state in which the drive fluid is discharged from the drive portion 30 (first and second pressure chambers P1 and P2) of the valve device 1 to the outside. Consequently, the drive fluid in the first and second pressure chambers P1 and P2 is discharged to the outside via the first and second fluid out-flow holes 34b and 34c, the fluid flow path 34a, and the fluid introduction path 42e. Consequently, the valve device 1 is brought into the closed state with the stem 17, the drive shaft 34, and the first and second pistons 31 and 33 moved to the bottom dead center by the biasing force of the compression coil spring 18.

### Stroke Adjustment Method

Next, a method of adjusting the stroke amount of the stem 17 will be described. The flow rate (Cv value) of the valve device 1 can be changed by adjusting the stroke amount of the stem 17.

In the first stroke adjustment portion 22, the position of the casing 21 relative to the body 10 in the up-down direction is adjusted by rotating the lower casing 25 with the nut 22A loosened. Consequently, the distance between the upper surface 17D of the stem 17 and the lower surface 25F of the second downward projecting portion 25C of the lower casing 25 is set to a desired distance. As a result, the upper limit value of the stroke amount of the stem 17 is set. At this time, the distance between the lower surface of the movable disk 42 and the upper surface of the flange 34D of the drive shaft 34 is determined to be equal to or more than the set upper limit value.

In the case where it is desired to finely adjust (for example, slightly decrease) the stroke amount of the stem 17, the stroke amount is finely adjusted using the second stroke adjustment portion 40. Specifically, the movable disk 42 is descended by removing the fixing screws 41D and rotating the handle 41. This makes the distance between the lower surface of the movable disk 42 and the upper surface of the flange 34D slightly shorter than the distance between the upper surface 17D of the stem 17 and the lower surface 25F of the second downward projecting portion 25C. Consequently, the stroke amount of the stem 17 is slightly decreased with the movable disk 42 moved closer to the flange 34D of the drive shaft 34. In this state, when the stem 17 is positioned at the top dead center, the upper surface of the flange 34D of the drive shaft 34 abuts against the lower surface of the movable disk 42, but the upper surface 17D of the stem 17 does not abut against the lower surface 25F of the second downward projecting portion 25C of the lower casing 25.

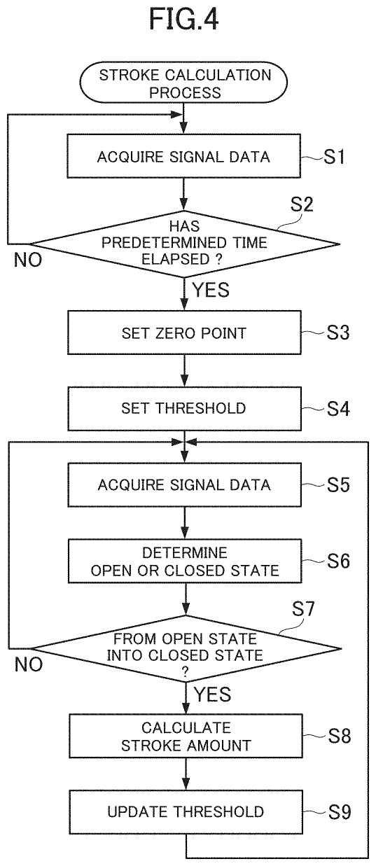

Next, the stroke calculation process performed by the controller 3 of the valve device 1 according to the present embodiment will be described with reference to FIG. 3 and FIG. 4. The stroke calculation process is executed by the controller 3 at all times during operation of the valve device 1 and while the sensor portion 2 and the controller 3 are energized.

FIG. 4 is a flowchart of the stroke calculation process.

The controller 3 acquires signal data (voltage value (measurement value)) transmitted from the Hall IC 2B of the sensor portion 2, and stores the signal data in the storage unit (step S1). The controller 3 determines whether or not a predetermined time (T1) has elapsed since the signal data are first acquired (step S2). The predetermined time (T1) is the time to open and close the valve device 1, for example the time since a three-way valve (not illustrated) for opening and closing the valve device 1 is brought into the open state, which is then brought into the closed state, until the next time the three-way valve is brought into the open state. However, the predetermined time (T1) is not limited thereto. In the case where the predetermined period has not elapsed (S2: NO), the controller 3 returns to step S1, and acquires the next signal data.

In the case where the predetermined time (T1) has elapsed (S2: YES), the controller 3 sets a minimum value (V1), among the voltage values of the signal data acquired during the predetermined time (T1), as a zero point (reference value) for stroke calculation (step S3). That is, a measurement value (voltage value) obtained by the sensor portion 2 when the valve device 1 is in the closed state is set as the zero point. The controller 3 acquires a voltage value that indicates a maximum value (V2), among the voltage values of the signal data acquired during the predetermined period (T1), and sets an intermediate value (Vm1) between the minimum value (V1) and the maximum value (V2) as a threshold (Vm1) for determining whether the valve device 1 is open or closed (step S4).

Next, the controller 3 acquires signal data from the Hall IC 2B of the sensor portion 2 (step S5), and compares the voltage value of the acquired signal data and the set threshold (Vm1) to determine whether the valve device 1 is open or closed (step S6). The controller 3 determines, on the basis of whether the valve device 1 was open or closed in the preceding determination, whether or not the valve device 1 has been brought from the open state into the closed state (step S7). In the case where the valve device 1 has not been brought from the open state into the closed state (S7: NO), the controller 3 returns to step S5.

In the case where the valve device 1 has been brought from the open state into the closed state (S7: YES), on the other hand, the controller 3 calculates the difference between the value (V1) of the zero point and a maximum value (V3), among the voltage values of signal data acquired during a certain time (t) immediately before the signal data acquired in step S5, and calculates the stroke amount corresponding to the difference (step S8). The stroke amount is calculated on the basis of the correlation between the amount of movement of the magnet A2 relative to the Hall element and variations in the voltage of the Hall element relative to the amount of movement, the correlation being obtained in advance. The calculated stroke amount may be displayed on a display unit such as a display.

The controller 3 calculates an intermediate value (Vm2) between the value (V1) of the zero point and the maximum value (V3) acquired in step S7, and updates the threshold (Vm2) for determining whether the valve device 1 is open or closed with the newly calculated value (step S9). For example, in the case where the stroke of the stem 17 is adjusted and the stroke amount is decreased as illustrated in FIG. 3, the threshold is updated to be decreased. After that, the controller 3 returns to step S5.

The valve device according to the present embodiment which has been described above includes the first and second stroke adjustment portions 22 and 40 which adjust the stroke amount of the stem 17 and the sensor portion 2 which detects displacement of the stem 17. Therefore, it is possible to grasp the stroke amount of the stem 17 after stroke adjustment. Hence, it is also possible to grasp the flow rate (Cv value) of the valve device 1.

The valve device 1 includes the controller 3 which sets a zero point for calculating the stroke of the stem 17 on the basis of a measurement value (voltage value) detected by the sensor portion 2 when the valve device 1 is in the closed state. Consequently, it is possible to accurately set the zero point for the stroke of the stem 17, and to accurately calculate the stroke amount of the stem 17. Further, it is possible to accurately set the zero point for the stroke of the stem 17 even if the seat 12 is degraded over time.

The controller 3 determines whether the valve device 1 is in the open state or the closed state on the basis of the measurement value from the sensor portion 2 and the threshold. Consequently, it is possible to accurately grasp whether the valve device 1 is in the open state or the closed state.

The controller 3 updates the threshold on the basis of the measurement value detected by the sensor portion 2 when the valve device 1 is in the open state and the closed state. Consequently, it is possible to accurately grasp whether the valve device 1 is in the open state or the closed state by updating the threshold, even if the stroke amount has been changed by the first and second stroke adjustment portions 22 and 40.

The present disclosure is not limited to the embodiment discussed above. A person skilled in the art could make a variety of additions, modifications, etc., within the scope of the present disclosure.

For example, while the sensor portion 2 is a Hall sensor in the embodiment described above, the sensor portion 2 may be a different displacement sensor such as a capacitance sensor. While the controller 3 sets the minimum value (V1) of the voltage values of the acquired signal data as the zero point (reference value) for stroke calculation, the controller 3 may set the maximum value (V2) as the zero point. While the controller 3 sets the minimum value (V1) of the voltage values of the acquired signal data as the zero point (reference value) for stroke calculation, the controller 3 may set an average value of the voltage values for a certain time as the zero point. The maximum value (V2, V3) may be replaced with an average value of the voltage values for a certain time. While the threshold is an intermediate value (Vm1) between the minimum value (V1) and the maximum value (V2), the present disclosure is not limited thereto, and the threshold may be a value that is closer to the minimum value (V1) than the intermediate value (Vm1).

What is claimed is:

1. A valve device comprising:
a body in which an in-flow path and an out-flow path are formed;
a valve element that is configured to open and close the in-flow path and the out-flow path;
a stem that is configured to move closer to and away from the body in order to cause the valve element to allow and block communication between the in-flow path and the out-flow path;
a stroke adjustment portion that is configured to adjust an amount of stroke of the stem; and
a displacement sensor that is configured to detect displacement of the stem.

2. The valve device according to claim 1, further comprising a controller that is configured to set a zero point for calculating the stroke of the stem on the basis of a measurement value detected by the displacement sensor when the valve device is in an open state or a closed state.

3. The valve device according to claim 2,
wherein the controller is configured to determine whether the valve device is in the open state or the closed state on the basis of the measurement value from the displacement sensor and a threshold.

4. The valve device according to claim 3,
wherein the controller is configured to update the threshold on the basis of the measurement value detected by the displacement sensor when the valve device is in the open state and the closed state.

5. The valve device according to claim 1,
wherein the stroke adjustment portion includes a first stroke adjustment portion and a second stroke adjustment portion provided at a different position from that of the first stroke adjustment portion.

6. The valve device according to claim 5, further comprising:
a bonnet in which a first threaded hole is formed and which is fixed to the body; and
an actuator that includes a casing and a drive portion accommodated in the casing, wherein
the casing has a cylindrical shape and includes a threaded engagement portion against which the stem is configured to be able to abut, the threaded engagement portion having an outer periphery provided with a first threaded portion to be screwed into the first threaded hole,
the drive portion includes a drive shaft coupled to the stem, the drive shaft configured to move closer to and away from the body together with the stem,
the first threaded portion and the first threaded hole constitute the first stroke adjustment portion,
the second stroke adjustment portion is provided in the casing on an opposite side of the threaded engagement portion from the drive portion,
the second stroke adjustment portion includes: a handle having a cylindrical shape, the handle being provided to be rotatable and including a second threaded hole; and a movable disk having an outer periphery provided with a second threaded portion to be screwed into the second threaded hole, with the drive shaft being able to abut against the movable disk,
the first stroke adjustment portion is configured to adjust the stroke amount of the stem by adjusting a position of the casing with respect to the body, by rotating the casing to rotate the first threaded portion of the threaded engagement portion with respect to the first threaded hole in the bonnet,
the second stroke adjustment portion is configured to adjust the stroke amount of the stem by adjusting a position of the movable disk with respect to the body, by rotating the handle to move the movable disk using the second threaded hole and the second threaded portion which are screwed to each other, and
a pitch of the second threaded portion and the second threaded hole is smaller than a pitch of the first threaded portion and the first threaded hole.
